(19) United States
(12) Patent Application Publication
(10) Pub. No.: US 2025/0067513 A1
(43) Pub. Date: Feb. 27, 2025

(54) Pipe Freezing Device

(71) Applicants: Kelly Miyashiro, Kapolei, HI (US); Floralyn Miyashiro, Kapolei, HI (US)

(72) Inventors: Kelly Miyashiro, Kapolei, HI (US); Floralyn Miyashiro, Kapolei, HI (US)

(21) Appl. No.: 18/586,693

(22) Filed: Feb. 26, 2024

Related U.S. Application Data
(60) Provisional application No. 63/578,458, filed on Aug. 24, 2023.

(51) Int. Cl. F28D 1/02; F28D 1/053

(52) U.S. Cl. CPC F28D 1/022; F28D 1/053

(57) ABSTRACT

A pipe freezing device is disclosed that facilitates the use of a pipe freezing method which changes the temperature of the ocean. The pipe freezing device comprises a liquid nitrogen component which is applied to at least one pipe. Thus, the liquid nitrogen component is used to make the temperature of the pipes just below freezing, thereby causing the water flowing through the pipes to become colder.

### CROSS-REFERENCE TO RELATED APPLICATION

The present application claims priority to, and the benefit of, U.S. Provisional Application No. 63/578,458, which was filed on Aug. 24, 2023, and is incorporated herein by reference in its entirety.

### FIELD OF THE INVENTION

The present invention relates generally to the field of pipe freezing devices. More specifically, the present invention relates to a pipe freezing device designed to change the temperature of the ocean. Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to improvements in pipe freezing devices. Generally, the ocean is constantly getting warmer because of global warming. Further, global warming can lead to an increase of natural disasters and other poor environmental conditions that harm communities. Accordingly, solutions are needed for cooling down ocean waters.

Furthermore, utilizing technology to cool ocean surface temperatures have received attention for the potential application of weakening a tropical cyclone ahead of landfall, or other sea-based storms. Here, the application of an ocean-warming device that artificially provides for ocean cooling could drastically weaken tropical cyclones over high sea surface temperatures and deep ocean mixed layer environments, especially for fast storm motion speeds.

Accordingly, there is a demand for an improved pipe freezing device that is designed to artificially change the temperature of the ocean. More particularly, there is a demand for a pipe freezing device that helps cool the ocean and reduce the effects of global warming.

Therefore, there exists a long-felt need in the art for a pipe freezing device that provides users with a pipe freezing device designed to change the temperature of the ocean. There is also a long-felt need in the art for a pipe freezing device that utilizes liquid nitrogen to freeze the pipe and cause water flowing through the pipes to freeze. Further, there is a long-felt need in the art for a pipe freezing device that allows users to implement the pipe freezing device into boats to freeze and cool down the ocean water. Moreover, there is a long-felt need in the art for a device that helps bring the ocean back to colder temperatures and reduce the effects of global warming. Further, there is a long-felt need in the art for a pipe freezing device that utilizes liquid nitrogen to make the temperature of the pipes just below freezing. Finally, there is a long-felt need in the art for a pipe freezing device that flows water through the cold pipes, such that the water will flow in warm and flow out cold.

The subject matter disclosed and claimed herein, in one embodiment thereof, comprises a pipe freezing device. The device facilitates the use of a pipe freezing method which changes the temperature of the ocean. The pipe freezing device comprises a liquid nitrogen component which is applied to at least one pipe. Thus, the liquid nitrogen component is used to make the temperature of the pipes just below freezing, thereby causing the water flowing through the pipes to become colder.

On a given ship, there will be containers of liquid nitrogen next to one or more pipes. These pipes typically extend from one end of the ship to the other. The liquid nitrogen is then used to cool the pipes to just below freezing. Water will flow through the pipes, thereby allowing the liquid nitrogen to make the pipes cooler and for the water to flow in warm and flow out cold.

In this manner, the pipe freezing device of the present invention accomplishes all of the foregoing objectives and provides users with a device that changes the temperature of the ocean. The device is liquid nitrogen applied to a pipe, such that the pipes are cooled and water within the pipes are also cooled.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a pipe freezing device. The device facilitates the use of a pipe freezing method which changes the temperature of the ocean. The pipe freezing device comprises a liquid nitrogen component which is applied to at least one pipe. Thus, the liquid nitrogen component is used to make the temperature of the pipes just below freezing, thereby causing the water flowing through the pipes to become colder.

In one embodiment, the present invention relates to a pipe freezing device using liquid nitrogen to cool down ocean water. Therefore, the method of freezing the pipe by using liquefied nitrogen that is colorless, odorless, tasteless, non-flammable, and quick cooling has the effect of cooling water flowing through the pipes, such that water flows into the pipes warm and flows out cold. The pipes are located on a ship. Thus, the cold water flowing out of the pipes can act to change the temperature of the ocean.

In one embodiment, the pipe freezing device utilizes any suitable boat, ship, vessel, etc., and/or private, commercial, or military watercraft, as is known in the art. The ship or other vessel is utilized to transport at least one pipe and to distribute the cold water from at least one pipe. Accordingly, the ship or other vessel can float or motor through a body of water, such as an ocean, sea, lake, river, etc. Further, as the ship moves through the body of water, the ship dispenses cold water out of at least one pipe, as needed to change the temperature of the ocean or other body of water the ship is sailing through.

In one embodiment, at least one pipes on the ship comprise copper pipe, steel pipes, stainless steel pipes, or any other suitable metal material as is known in the art. The pipes can be any suitable shape and size as is known in the art. Further, the pipes can be any diameter and/or length as is known in the art, depending on the needs and/or wants of a user. Typically, the pipes are of a length that the pipes extend from one end of the ship to the other end. Water can thus enter the pipe at one end and travel the length of the ship, coming out cold at the other end and entering the ocean to cool it down. Further, multiple pipes can be utilized on the ship, allowing for more water to be cooled at once. Any suitable number of pipes can be utilized as is known in the art, depending on the size of the ship being used.

In one embodiment, liquid nitrogen is utilized to cool the pipes to just below freezing. Generally, on a given ship, there will be containers of liquid nitrogen, positioned next to one or more pipes. The liquid nitrogen containers are used to make the temperature of the pipes just below freezing, thereby causing the water flowing through the pipes to become colder. Further, the liquid nitrogen is inserted into the pipes via a nozzle and hose secured to the liquid nitrogen container. Liquid nitrogen is sprayed directly into the pipes via the nozzle. The amount of liquid nitrogen used to bring the pipe to just below freezing is determinant on the size of the pipe being used.

In one embodiment, multiple ships are used simultaneously to cool a large body of water. Each of these ships would have multiple pipes on board that utilize liquid nitrogen to cool the water within the pipes.

In yet another embodiment, the pipe freezing device comprises a plurality of indicia.

In yet another embodiment, a method of artificially cooling down ocean water is disclosed. The method includes the steps of providing a pipe freezing device comprising a liquid nitrogen component. The method also comprises applying the liquid nitrogen component to at least one pipe. Further, the method comprises making the temperature of at least one pipe just below freezing via the liquid nitrogen component. Finally, the method comprises sending water to flow through at least one frozen pipe, such that water flows in warm and flows out cold.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the pipe freezing device of the present invention showing the pipes of the device in accordance with the disclosed architecture;

FIG. 2 illustrates a perspective view of one embodiment of the pipe freezing device of the present invention showing the liquid nitrogen tanks of the device in accordance with the disclosed architecture;

FIG. 3 illustrates a perspective view of one embodiment of the pipe freezing device of the present invention showing the pipes and liquid nitrogen on a boat in accordance with the disclosed architecture;

FIG. 4 illustrates a perspective view of one embodiment of the pipe freezing device of the present invention showing the device in use in accordance with the disclosed architecture; and

FIG. 5 illustrates a flowchart showing the method of artificially cooling down ocean water in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a pipe freezing device that provides users with a pipe freezing device designed to change the temperature of the ocean. There is also a long-felt need in the art for a pipe freezing device that utilizes liquid nitrogen to freeze the pipe and cause water flowing through the pipes to freeze. Further, there is a long-felt need in the art for a pipe freezing device that allows users to implement the pipe freezing device into boats to freeze and cool down the ocean water. Moreover, there is a long-felt need in the art for a device that helps bring the ocean back to colder temperatures and reduce the effects of global warming. Further, there is a long-felt need in the art for a pipe freezing device that utilizes liquid nitrogen to make the temperature of the pipes just below freezing. Finally, there is a long-felt need in the art for a pipe freezing device that flows water through the cold pipes, such that the water will flow in warm and flow out cold.

The present invention, in one exemplary embodiment, is a novel pipe freezing device. The device facilitates the use of a pipe freezing method which changes the temperature of the ocean. The pipe freezing device comprises a liquid nitrogen component which is applied to at least one pipe. Thus, the liquid nitrogen component is used to make the temperature of the pipe just below freezing, thereby causing the water flowing through the pipe to become colder. The present invention also includes a novel method of artificially cooling down ocean water. The method includes the steps of providing a pipe freezing device comprising a liquid nitrogen component. The method also comprises applying the liquid nitrogen component to at least one pipe. Further, the method comprises making the temperature of at least one pipe just below freezing via the liquid nitrogen component. Finally, the method comprises sending water to flow through at least one frozen pipe, such that water flows in warm and flows out cold.

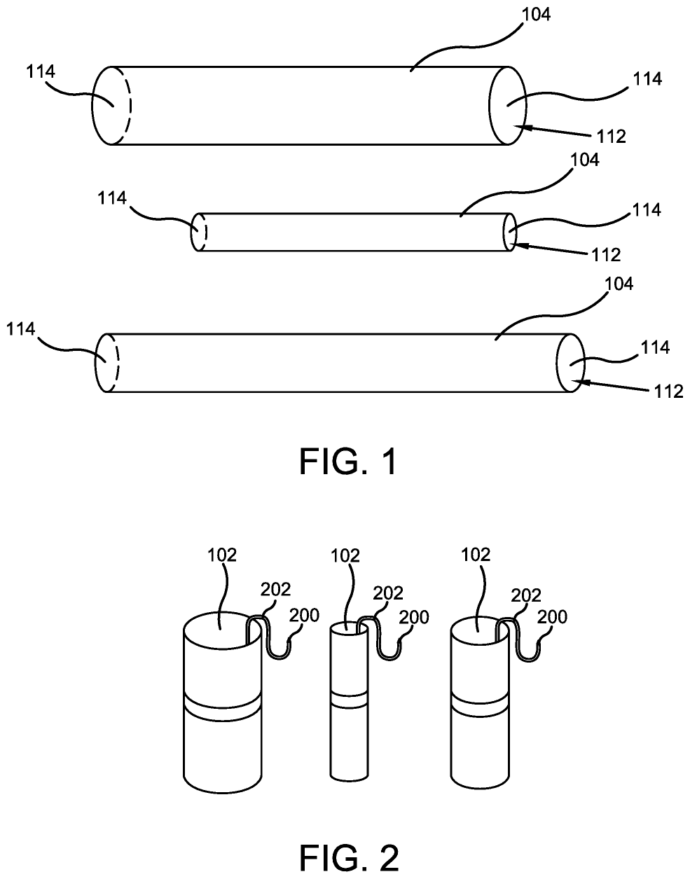

Referring initially to the drawings, FIG. 1 illustrates a perspective view of one embodiment of the pipe freezing device 100 of the present invention. In the present embodiment, the pipe freezing device 100 is an improved pipe freezing device 100 that is designed to change the temperature of the ocean. Specifically, the pipe freezing device 100 comprises a liquid nitrogen component 102 that is applied to at least one pipe 104, to bring the temperature of the pipe 104 to just below freezing, causing the water 106 flowing through the pipes 104 to become colder.

Generally, the present invention relates to a pipe freezing device 100 using liquid nitrogen 102 to cool down ocean water 108. Therefore, the method of freezing the pipe 104 by using liquefied nitrogen 102 that is colorless, odorless, tasteless, non-flammable, and quick cooling has the effect of cooling water 106 flowing through the pipe 104, such that water 106 flows into the pipe 104 warm and flows out cold. The pipes 104 are typically located on a ship 110 but can be positioned in any suitable device as is known in the art, depending on the needs and/or wants of a user. Thus, the cold water 106 flowing out of the pipes 104 can act to change the temperature of the ocean 108.

Furthermore, at least one pipe 104 on the ship 110 comprise copper pipes, steel pipes, stainless steel pipes, or pipes comprised of any other suitable metal material as is known in the art. The pipes 104 can be any suitable shape and size as is known in the art, but are typically cylindrical or tube-like in shape with an open interior cavity 112 and opposing ends 114. Further, the pipes 104 can be any diameter and/or length as is known in the art, depending on the needs and/or wants of a user. Typically, the pipes 104 are of a length that the pipes 104 extend from one end of the ship 110 to the other end. Water 106 can thus enter the pipe 104 at one end and travel the length of the ship 110, coming out cold at the other end and entering the ocean 108 to cool it down. Further, multiple pipes 104 can be utilized on the ship 110, allowing for more water 106 to be cooled at once. Any suitable number of pipes 104 can be utilized as is known in the art, depending on the size of the ship 110 being used and the amount of water 108 needing to be cooled.

As shown in FIG. 2, liquid nitrogen 102 is utilized to cool the pipes 104 to just below freezing. Generally, on a given ship 110, there will be containers of liquid nitrogen 102, positioned next to one or more pipes 104. The liquid nitrogen containers 102 are used to make the temperature of the pipes 104 just below freezing, thereby causing the water 106 flowing through the pipes 104 to become colder. Further, the liquid nitrogen 102 is inserted into the pipes 104 via a nozzle 200, and hose 202 secured to the liquid nitrogen container 102. Liquid nitrogen 102 is sprayed directly into the pipes 104 via the nozzle 200. The amount of liquid nitrogen 102 used to bring the pipe 104 to just below freezing is determinant on the size of the pipe 104 being used.

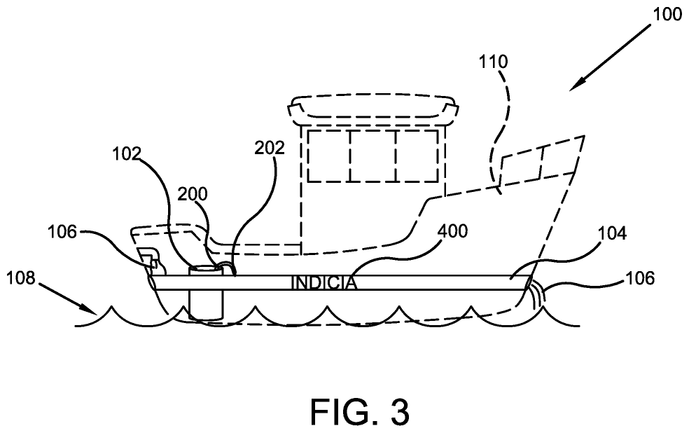

As shown in FIG. 3, the pipe freezing device 100 utilizes any suitable boat, ship 110, vessel, etc., and/or private, commercial, or military watercraft, as is known in the art. The ship 110 or other vessel is utilized to transport the at least one pipe 104 and to distribute the cold water 106 from at least one pipe 104. Accordingly, the ship 110 or other vessel can float or motor through a body of water 108, such as an ocean, sea, lake, river, etc. Further, as the ship 110 moves through the body of water 108, the ship 110 dispenses cold water 106 out of at least one pipe 104, as needed to change the temperature of the ocean 108 or other body of water the ship 110 is sailing through.

In one embodiment, multiple ships 110 are used simultaneously to cool a large body of water 108. Each of these ships 110 would have multiple pipes 104 on board that utilize liquid nitrogen 102 to cool the water 106 within the pipes 104.

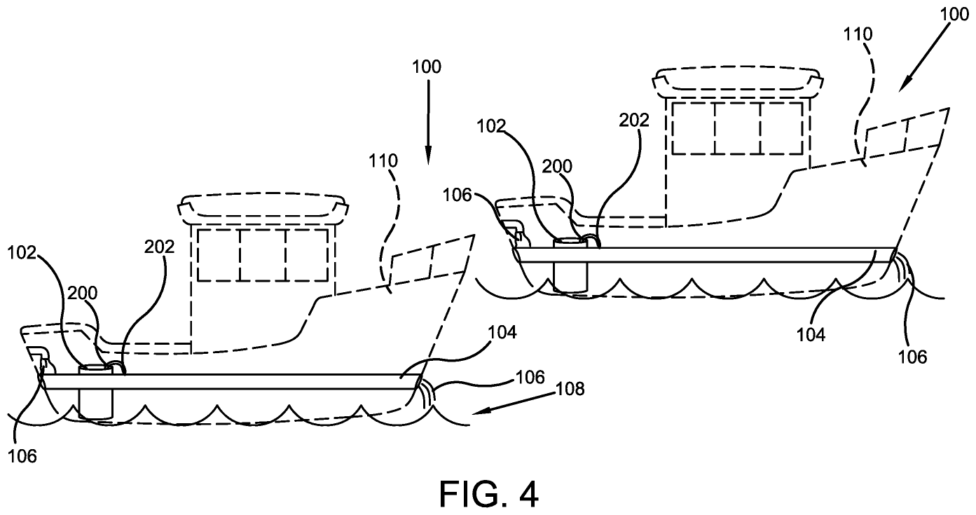

As shown in FIG. 4, in use, the present invention utilizes liquid nitrogen 102 to cool down ocean water 108. Specifically, at least one pipe 104 is positioned on a ship 110 or other vessel which is located on a body of water 108, such as an ocean, sea, lake, river, etc. The liquid nitrogen 102, which is colorless, odorless, tasteless, non-flammable, and quick cooling, is applied to the pipes 104 on board the ship 110. Application of the liquid nitrogen 102, brings the temperature of the pipes 104 to just below freezing. Thus, water 106 flowing through the pipes 104 is cooled. Accordingly, water 106 flows into the pipes 104 warm and flows out cold. Thus, the cold water 106 flowing out of the pipes 104 can act to change the temperature of the ocean water 108.

In yet another embodiment, the pipe freezing device 100 comprises a plurality of indicia 400. The liquid nitrogen containers 102 and/or the pipes 104 of the device 100 may include advertising, a trademark, or other letters, designs, or characters, printed, painted, stamped, or integrated into the liquid nitrogen containers 102 and/or pipes 104, or any other indicia 400 as is known in the art. Specifically, any suitable indicia 400 as is known in the art can be included, such as, but not limited to, patterns, logos, emblems, images, symbols, designs, letters, words, characters, animals, advertisements, brands, etc., that may or may not be pipes, cold water, or brand related.

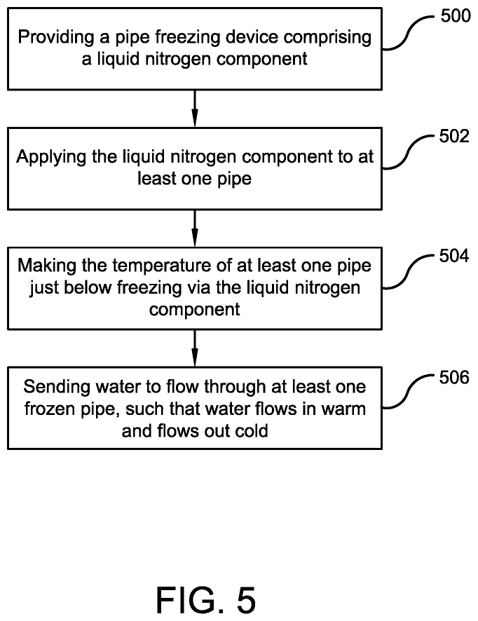

FIG. 5 illustrates a flowchart of the method of artificially cooling down ocean water. The method includes the steps of at 500, providing a pipe freezing device comprising a liquid nitrogen component. The method also comprises at 502, applying the liquid nitrogen component to at least one pipe. Further, the method comprises at 504, making the temperature of the at least one pipe just below freezing via the liquid nitrogen component. Finally, the method comprises at 506, sending water to flow through at least one frozen pipe, such that water flows in warm and flows out cold.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “pipe freezing device”, “pipe device”, “freezing device”, and “device” are interchangeable and refer to the pipe freezing device 100 of the present invention.

Notwithstanding the foregoing, the pipe freezing device 100 of the present invention can be of any suitable size and configuration as is known in the art without affecting the overall concept of the invention, provided that it accomplishes the above-stated objectives. One of ordinary skill in the art will appreciate that the pipe freezing device 100 as shown in FIGS. 1-5 is for illustrative purposes only, and that many other sizes and shapes of the pipe freezing device 100 are well within the scope of the present disclosure. Although the dimensions of the pipe freezing device 100 are important design parameters for user convenience, the pipe freezing device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A pipe freezing device that is designed to change the temperature of the ocean, the pipe freezing device comprising:
a liquid nitrogen component; and
at least one pipe;
wherein the liquid nitrogen component is applied to at least one pipe; and
further wherein water flowing through at least one pipe becomes colder as the water exits at least one pipe.

2. The pipe freezing device of claim 1, wherein liquid nitrogen of the liquid nitrogen component is colorless, odorless, tasteless, non-flammable, and provides a quick cooling effect on at least one pipe.

3. The pipe freezing device of claim 2, wherein at least one pipe is a copper or steel pipe.

4. The pipe freezing device of claim 3, wherein at least one pipe is cylindrical with an open interior cavity and opposing ends.

5. The pipe freezing device of claim 4, wherein at least one pipe extends from one end of a ship to an opposite end.

6. The pipe freezing device of claim 5, wherein multiple pipes can be utilized on the ship to cool water simultaneously.

7. The pipe freezing device of claim 6, wherein the liquid nitrogen component is utilized to cool the at least one pipe to just below freezing, thereby causing the water flowing through the at least one pipe to become colder.

8. The pipe freezing device of claim 7, wherein the liquid nitrogen is inserted into at least one pipe via a nozzle and a hose secured to the liquid nitrogen component.

9. The pipe freezing device of claim 8, wherein the liquid nitrogen is sprayed directly into at least one pipe via the nozzle.

10. The pipe freezing device of claim 9, wherein the ship can be a private, commercial, or military watercraft.

11. The pipe freezing device of claim 10, wherein the ship is utilized to transport at least one pipe and to distribute cold water from at least one pipe into a body of water.

12. The pipe freezing device of claim 11, wherein multiple ships with multiples pipes are used simultaneously to cool a large body of water.

13. A pipe freezing device that is designed to change the temperature of the ocean, the pipe freezing device comprising:
a liquid nitrogen component; and
at least one pipe which is cylindrical with an open interior cavity and opposing ends;
wherein liquid nitrogen of the liquid nitrogen component is colorless, odorless, tasteless, non-flammable, and provides a quick cooling effect on the at least one pipe;
wherein the liquid nitrogen component is applied to the at least one pipe and is utilized to cool the at least one pipe to just below freezing, thereby causing the water flowing through the at least one pipe to become colder;
wherein the at least one pipe extends from one end of a ship to an opposite end;
wherein water flowing through the at least one pipe becomes colder as the water exits the at least one pipe; and
further wherein the ship is utilized to transport at least one pipe and to distribute cold water from at least one pipe into a body of water.

14. The pipe freezing device of claim 13 further comprising a plurality of indicia.

15. The pipe freezing device of claim 13, wherein at least one pipe is a copper or steel pipe.

16. The pipe freezing device of claim 13, wherein the liquid nitrogen is inserted into at least one pipe via a nozzle and a hose secured to the liquid nitrogen component.

17. The pipe freezing device of claim 16, wherein the liquid nitrogen is sprayed directly into at least one pipe via the nozzle.

18. The pipe freezing device of claim 13, wherein the ship can be a private, commercial, or military watercraft.

19. The pipe freezing device of claim 13, wherein multiple ships with multiples pipes are used simultaneously to cool a large body of water.

20. A method of artificially cooling down ocean water, the method comprising the following steps:
providing a pipe freezing device comprising a liquid nitrogen component;
applying the liquid nitrogen component to at least one pipe;
making the temperature of at least one pipe just below freezing via the liquid nitrogen component; and
sending water to flow through at least one frozen pipe, such that water flows in warm and flows out cold.
